(19) United States
(12) Patent Application Publication
(10) Pub. No.: US 2003/0188479 A1
(43) Pub. Date: Oct. 9, 2003

(54) Floral container with decorative feature background

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/400,202

(22) Filed: Mar. 26, 2003

Related U.S. Application Data
(63) Continuation-in-part of application No. 09/687,220, filed on Oct. 13, 2000, now abandoned.
Application No. 09/687,220 is a continuation-in-part of application No. 09/399,858, filed on Sep. 21, 1999, now abandoned.

(51) Int. Cl. A01G 9/02

(52) U.S. Cl. 47/66.7

(57) ABSTRACT

A floral container having a decorative feature on the outer surface thereof and having a removable protective layer disposed over the decorative feature and attached to the outer surface of the floral container and a method of use thereof wherein a botanical item is cultivated at a cultivation location then transported to a point of sale location where the protective layer is removed prior to sale of the floral container having the botanical item therein.

### CROSS REFERENCE TO RELATED APPLICATION

The present application is a continuation-in-part of U.S. Ser. No. 09/687,220, filed Oct. 13, 2000, now abandoned, which is a continuation-in-part of U.S. Ser. No. 09/399,858, filed Sep. 21, 1999, the specification of each of which is hereby expressly incorporated herein by reference in its entirety.

### FIELD OF THE INVENTION

This invention generally relates to the field of floral containers and their use.

### BRIEF DESCRIPTION OF THE DRAWINGS

FIG. 1 is a perspective view of a floral container constructed in accordance with the present invention.

FIG. 2 is a perspective view of the floral container of FIG. 1 having a plant therein wherein a protective layer is partially peeled away from the surface of the floral container.

### DETAILED DESCRIPTION OF THE INVENTION

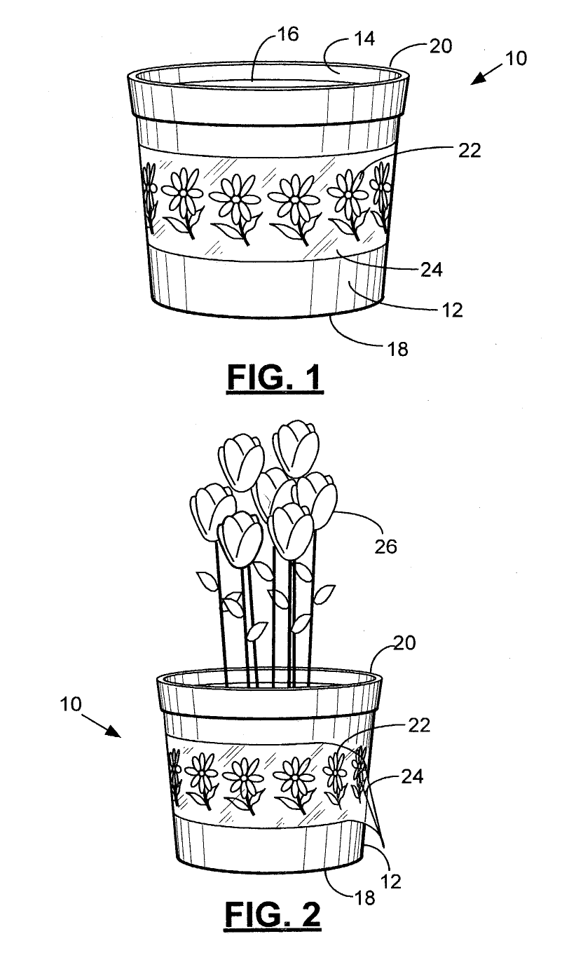

Shown in FIGS. 1 and 2 is a floral container designated by the general reference numeral 10. The floral container 10 has an outer peripheral surface 12, an inner peripheral surface 14, an inner retaining space 16, a lower end 18 and an upper rim 20. Disposed on the outer peripheral surface 12 is a decorative feature 22. The decorative feature 22 can be any feature on the outer peripheral surface 12 on the floral container 10 which is desired to be protected from scratching, abrasion, moisture or other actions or phenomena which may mar, disfigure or adversely affect the decorative feature 22.

The decorative feature 22 may be a decorative design, a decorative pattern, or an intaglio printed, imposed or embossed upon, engraved in or otherwise disposed upon the outer peripheral surface 12. It may be a logo, trademark, photographic image, or a holographic image for example.

Disposed over the decorative feature 22 is a protective layer 24 which is attached to a portion of the outer peripheral surface 12 of the floral container 10. Preferably the protective layer 24 is connected to the outer peripheral surface 12 of the floral container 10 by an adhesive or cohesive bonding material. In one embodiment, the protective layer 24 may be a removable lacquer or lacquer-like material which is disposed upon the decorative feature 22 for example by spraying or brushing and which can be peeled off after drying. In this manner the protective layer 24 is not connected to the floral container 10 by a separate adhesive or cohesive bonding material, but by the adhesive properties of the lacquer or lacquer-like material itself.

In any event, the protective layer 24 can be removed readily from the outer peripheral surface 12 of the floral container 10 by lifting a portion of the protective layer 24 and peeling the protective layer 24 from the outer peripheral surface 12 as shown in FIG. 2, thereby exposing the decorative feature 22. Generally the protective layer 24 will be removed from the floral container 10 only after a botanical item 26 has been cultivated therein, the function of the protective layer 24 generally being to protect the decorative feature 22 during cultivation of the botanical item 26, during shipment or transport of the floral container 10 and botanical item 26, or during the handling of or shipment of the floral container 10 alone.

The protective layer 24 is preferably transparent but may be translucent or opaque. The protective layer 24 is preferably a polymer film such as a synthetic polymer film or a naturally-occurring polymer film such as polypropylene or cellophane, respectively. Alternatively, the protective layer 24 may be any material which can be attached to and peeled or removed from the outer peripheral surface 12 of the floral container 10, for example paper, metal foil or fabric.

Where used herein, the term “floral container” is intended to mean any device which can be used to contain a floral grouping or plant, such as, but not limited to, a clay pot, a plastic pot, a foam pot, a pot made from fibers or other organic material, such as wood or cellulose, a ceramic pot, a vase, or a metal pot.

Preferably, the floral container 10 is used during a plant cultivation process wherein the botanical item 26 is planted then cultivated in the floral container 10, wherein the protective layer 24 protects the decorative feature 22 from damage by marring, abrasion, or moisture during the cultivation process as discussed elsewhere herein. The protective layer 24 can then be removed from the floral container 10 after the cultivation process to expose the decorative feature 22.

Preferably after the botanical item 26 has been cultivated within the floral container 10 at a cultivation location such as a greenhouse or nursery, the floral container 10 with the botanical item 26 therein is transported to a point of sale location which is remote from the cultivation location. The point of sale location may be a supermarket, a department store, a grocery of a nursery, for example (but not limited to) as long as the point of sale location is physically separate from the cultivation location and physical transportation of the floral container from the cultivation location to the point of sale location is required. Once at the point of sale location the protective layer 24 is preferably removed from the floral container 10 to expose the decorative feature 22.

The term “botanical item” when used herein means a natural or artificial herbaceous or woody plant, taken singly or in combination. The term “botanical item” also means a propagule or any portion or portions of natural or artificial herbaceous or woody plants including stems, leaves, flowers, blossoms, buds, blooms, cones, or roots, taken singly or in combination, or in groupings of such portions such as bouquet or floral grouping.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping comprises a bloom or foliage portion and a stem portion. Further, the floral grouping may comprise a growing potted plant having a root portion (not shown) as well. However, it will be appreciated that the floral grouping may consist only of a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule.”

The term “growing medium” when used herein means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “propagule” when used herein means any structure capable of being propagated or acting as an agent of reproduction including seeds, shoots, stems, runners, tubers, plants, leaves, roots or spores. The term “bonding material” when used herein means an adhesive, frequently a pressure sensitive adhesive, or a cohesive. When the bonding material is a cohesive, a similar cohesive material must be placed on adjacent surface of the pot and protective layer for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material” when used herein also means a heat sealing lacquer or hot melt material which may be applied to the material and, in this instance, heat, sound waves, or vibrations, also must be applied to effect the sealing.

Changes may be made in the construction and the operation of the various components, elements and assemblies described herein or in the steps or the sequence of steps of the methods described herein without departing from the spirit and scope of the invention as defined in the following claims.

What is claimed is:

1. A method of cultivating a botanical item, comprising:
providing a floral container having an outer peripheral surface and having a decorative feature on the outer peripheral surface, the floral container having a protective layer disposed over the decorative feature, the protective layer attached directly to a portion of the outer peripheral surface of the floral container and removable therefrom to uncover the decorative feature;
cultivating a botanical item in the floral container at a cultivation location;
transporting the floral container to a point of sale location which is remote from the cultivation location; and
removing the protective layer from the floral container after the floral container has been transported to the point of sale location which is remote from the cultivation location, thereby exposing the decorative feature of the floral container prior to sale of the floral container at the point of sale location.

2. The method of claim 1 wherein, in the step of providing a floral container, the floral container is a flower pot.

3. The method of claim 1 wherein, in the step of providing a floral container, the protective layer is attached to the outer peripheral surface of the floral container by an adhesive or cohesive bonding materials.

4. The method of claim 1 wherein, in the step of providing a floral container, the protective layer is transparent.

5. The method of claim 1 wherein, in the step of providing a floral container, the protective layer is opaque or translucent.

6. The method of claim 1 wherein, in the step of providing a floral container, the protective layer is a lacquer.

7. The method of claim 1 wherein, in the step of providing a floral container, the protective layer is resistant to abrasion.

8. The method of claim 1 wherein, in the step of providing a floral container, the protective layer is a polymer film.

9. The method of claim 1 wherein, in the step of cultivating, the cultivation location is a greenhouse, or nursery.

10. The method of claim 1 wherein, in the step of transporting the floral container to a point of sale location, the point of sale location is a supermarket, a department store, a grocery, or a nursery.
